(19) United States
(12) Patent Application Publication
(10) Pub. No.: US 2026/0225736 A1
(43) Pub. Date: Aug. 6, 2026

(54) SEPARATION DEVICE FOR CRYOGENIC PROPELLANT TANKS OF ROCKET STAGES

(71) Applicant: ArianeGroup GmbH, TAUFKIRCHEN (DE)

(72) Inventor: Kei Philipp BEHRUZI, BREMEN (DE)

(21) Appl. No.: 19/453,448

(22) Filed: Jan. 20, 2026

(30) Foreign Application Priority Data
Jan. 31, 2025 (EP) 25155254.3

(51) Int. Cl. B64G 1/40

(52) U.S. Cl. CPC B64G 1/4021

(57) ABSTRACT

A separation device for a cryogenic propellant tank of a rocket stage, wherein a secondary flow leading to the micropropulsion unit is structurally separated from a primary flow leading to a main engine, wherein a fan-shaped internal structure, through which the cryogenic liquid has to flow in order to reach the micropropulsion unit, is arranged in the inlet region of the secondary flow, wherein the internal structure is designed in such a way that it fills with liquid under zero gravity conditions and under only low acceleration, as well as during the operation of the micropropulsion unit under acceleration.

### CROSS-REFERENCES TO RELATED APPLICATIONS

This application claims the benefit of European Patent Application Number 25155254.3 filed on Jan. 31, 2025, the entire disclosure of which is incorporated herein by way of reference.

### FIELD OF THE INVENTION

The invention pertains to a separation device for installation in a cryogenic propellant tank of a rocket stage, as well as to a propellant tank.

### BACKGROUND OF THE INVENTION

In a propellant tank used for storing liquid cryogenic propellants in rocket stages, the intake of gas bubbles during orbital operation poses a problem. The cryogenic engine intended for orbital operation can overheat and be destroyed due to this intake of gas bubbles. In rocket stages, the orbital engine ensures that the liquid remains at the tank outlet during phases not powered by the main engine such that the main engine can be reignited. If the orbital engine fails, the main engine cannot ignite correctly.

The reignition of rocket stages powered with cryogenic propellants such as liquid hydrogen and oxygen typically is achieved by means of cold gas, wherein a pre-acceleration is generated by releasing the cold pressurized gas from the cryogenic tanks via a system of control nozzles. This pre-acceleration ensures that the propellant collects at the tank outlet, thereby enabling reignition after a ballistic flight phase. A disadvantage of this can be seen in that a sufficient quantity of propellant gas (helium) must be available for maintaining the tank pressure in the operating range of the engine.

As an alternative to pre-acceleration with cold gas, it is also possible to use a micropropulsion unit, which burns the cryogenic liquids directly, with the aim of reducing the amount of helium required and increasing pre-acceleration compared to the operation with cold gas. However, this makes it necessary to position a limited quantity of propellant at the inlet of the micropropulsion unit in a stable manner in order to enable the operation of this orbital engine.

In order to keep the propellant stable against disruptive accelerations, satellites with storable, non-cryogenic propellants use fan-shaped structures that are arranged in the outlet region of a propellant tank and utilize the capillary forces of the propellants. A structure of this type is disclosed in European patent EP 2 768 731 B1. However, since rocket engines have a high propellant requirement at high mass flow rates, these fan-shaped structures are deemed unsuitable for installation in a propellant tank of a rocket stage.

The invention is based on an objective of developing a separation device for installation in a cryogenic propellant tank of a rocket stage, wherein said separation device prevents gas from entering a liquid line under zero gravity or low gravity conditions and enables the operation of a main engine. The invention furthermore aims to develop a propellant tank for cryogenic propellants that allows a flexible and robust operation.

### SUMMARY OF THE INVENTION

The objectives may be attained with a separation device and/or a propellant tank with the characteristics of one or more of the embodiments described herein.

An inventive separation device for installation in a cryogenic propellant tank of a rocket stage for cryogenic liquid propellants has a base body and at least one liquid collector. The base body has at least one first region that can be fluidically connected to a first outlet line of the propellant tank. In addition, the base body has at least one second region that can be fluidically connected to a second outlet line of the propellant tank. The at least one liquid collector is arranged in the second region. It has an inlet opening for receiving cryogenic propellant from the tank interior and an outlet opening for discharging the received propellant in the direction of the second outlet line. The liquid collector has an internal structure, which is designed in such a way that the propellant enters the liquid collector based on capillary forces. It is preferred that the first outlet line or liquid line is connected to a main engine of the rocket stage and that the second outlet line or liquid line is connected to an auxiliary engine (micropropulsion unit or orbital engine).

The present invention prevents the ingress of gas bubbles by means of a fan that is arranged upstream of the orbital engine and blocks the ingress of gas bubbles by exploiting the capillary properties of the liquids in that a liquid buffer is held in a capillary manner in a fan upstream of the engine inlet.

The capillary forces cause the cryogenic propellant, e.g. liquid oxygen, to collect in the internal structure in the ballistic flight phase or in flight phases with low acceleration and to be subsequently available during the burn period of the orbital engine. The internal structure of the liquid collector empties during the operation of the engine if no propellant from the tank is accumulated on the liquid collector. Once the propellant from the tank is accumulated again on the liquid collector, the internal structure of the liquid collector is refilled with the cryogenic propellant from the propellant tank under zero gravity conditions or under low acceleration, namely even when the orbital engine is running.

The separation device is designed in such a way that the liquid collector also fills with liquid under low acceleration conditions after the main engine is shut down. During this filling process, a certain proportion of liquid simultaneously flows through the liquid collector in order to operate the orbital engine. The acceleration caused by the orbital engine ensures that the propellant remains at the tank outlet and reignition of the main engine can take place at any time. The orbital engine (micropropulsion unit) practically is used for preconditioning the propellant for the main engine.

In other words, the present invention attains the above-defined objective in that the secondary flow leading to the micropropulsion unit is separated from the primary flow by means of partition walls. A fan-shaped internal structure, through which the liquid has to flow in order to reach the micropropulsion unit, is arranged in the inlet region of the secondary flow. In this case, the internal structure is designed in such a way that it is also filled when the micropropulsion unit operates under acceleration.

The separation device may have an internal structure in the form of a plurality of partition sheets, the respective side clearance of which tapers from the inlet opening in the direction of the outlet opening. The partition sheets practically are arranged radially and span a segment of a circle (arc segment). Viewed radially from outside, the partition sheets extend toward one another radially inward. The capillary forces acting upon the propellant can be individually adapted to the respective auxiliary engine and the occurring accelerations with the number of partition sheets.

The partition sheets particularly may be arranged in a fluid-tight housing that is fluidically connected to its surroundings via the inlet opening and the outlet opening. This measure prevents leakage flows through the housing.

Viewed in the flow direction of the propellant entering the internal structure, the inlet opening is arranged radially outside on the circumference and the outlet opening is arranged radially inside axially in a housing bottom. The intake of hot propellant gases into the internal structure is effectively prevented due to the fact that the inlet opening is not arranged on the side of the cover, but rather on the front side. Since the outlet opening is arranged on the bottom side, the collected propellant is also kept away from hot propellant gas in the interior of the tank.

In order to be able to utilize each partition sheet or their intermediate spaces, it is advantageous if the inlet opening and the outlet opening respectively extend over all partition sheets and therefore over all intermediate spaces. The width of the intermediate spaces is defined by the side clearances. The outlet opening may be designed, for example, in a crescent-shaped manner.

The receptivity of the internal structure or the capillary effect can be respectively optimized if the partition sheets are spaced apart from a rear housing wall by a distance that is no greater than their minimal side clearance.

In order to prevent gas from collecting in the intermediate spaces of the partition sheets, these partition sheets may respectively have at least one row of holes on their upper and/or lower side. The partition sheets therefore may be perforated in their upper edge region and in their lower edge region. The spacing between the individual holes of a row depends on the side clearance of the partition sheets. This means that the holes are spaced apart from one another by a smaller distance on the radially inner side and by a greater distance on the radially outer side. If the partition sheets are also enclosed on their front side in the region of the inlet opening, holes for discharging gas from the intermediate spaces may also be formed in this upper enclosure and lower enclosure.

A system is installed in order to prevent the main engine from also using the propellant collected in the internal structure during its operation, wherein said system is designed in such a way that, when propellant is withdrawn via the first outlet line, a residual quantity of propellant remains in the internal structure in order to thereby enable ignition of the orbital engine at any time.

A heat shield preferably is provided in order to shield the liquid collector from hot propellant gases in the tank interior.

An inventive cryogenic propellant tank for a rocket stage has an inventive separation device and thereby allows a flexible and robust operation of a main engine.

Other advantageous embodiments of the invention are disclosed in further dependent claims.

### BRIEF DESCRIPTION OF THE DRAWINGS

A preferred embodiment of the invention is described in greater detail below with reference to the figures. In these figures,

FIG. 1 shows a longitudinal section through a lower portion of an inventive propellant tank with an inventive separation device positioned in the region of the tank bottom,

FIG. 2 shows an individual perspective view of the separation device,

FIG. 3 shows a perspective top view of an inventive liquid collector of the separation device,

FIG. 4 shows a perspective bottom view of the liquid collector, and

FIG. 5 shows a section through the liquid collector.

### DETAILED DESCRIPTION OF THE PREFERRED EMBODIMENTS

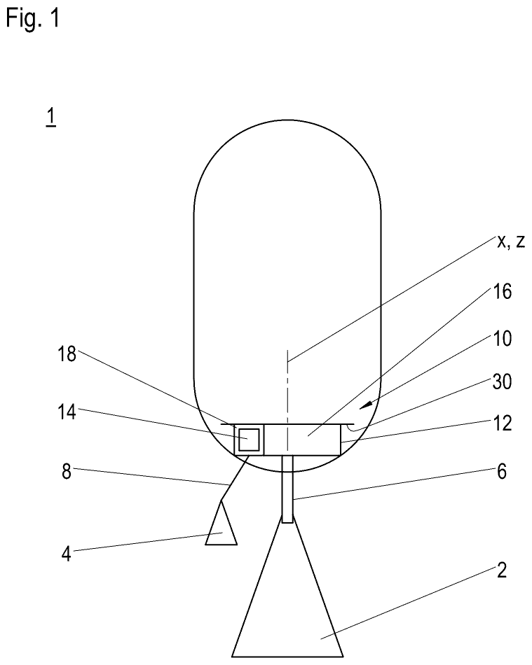

FIG. 1 shows a longitudinal section through an inventive propellant tank 1 of a rocket stage. Cryogenic propellant such as liquid oxygen and helium is stored in the tank interior. The propellant serves for operating a main engine 2 and an auxiliary engine, e.g. an orbital engine. The main engine 2 provides the thrust required to propel the rocket stage. The orbital engine 4 ensures that during phases not powered by the main engine 2, in which no gravitational force or only a slight acceleration acts upon the rocket engine, the liquid remains at the tank outlet for the main engine 2 such that the main engine 2 can be reignited.

In order to supply the propellant to the engines 2, 4, the propellant tank 1 has two outlet lines or liquid lines 6, 8, wherein one of said outlet lines (first outlet line 6) leads to the main engine 2 and the other outlet line (second outlet line 8) leads to the orbital engine 4.

An inventive separation device 10 is arranged in the tank interior in the bottom region of the propellant tank 1. The separation device 10 has a base body 12 and a liquid collector 14.

The base body 12 is divided into a first region 16 and at least one second region 18. The first region 16 produces a fluidic connection with the first outlet line 6 such that propellant can be withdrawn from the tank interior and fed to the main engine 2. The second region 18 produces a fluidic connection with the second outlet line 8 such that propellant can be withdrawn from the tank interior and fed to the auxiliary engine 4. The liquid collector 14 is arranged in the second region 18 and causes the liquid propellant to enter the liquid collector 14 and to collect therein based on capillary forces and therefore particularly under zero gravity conditions or under only low acceleration. The separation device 10 and particularly the liquid collector 14 are described in greater detail below with reference to the following figures.

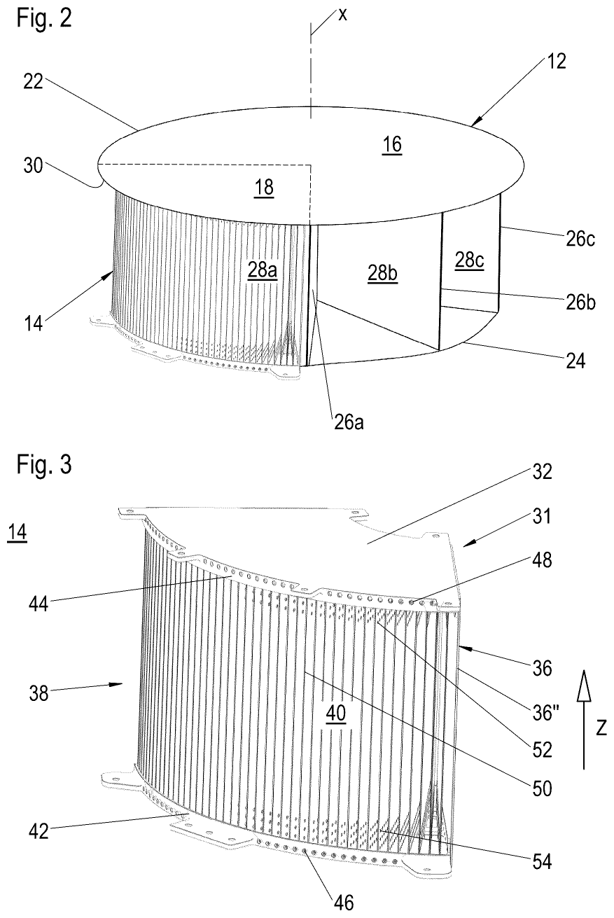

FIG. 2 shows the separation device 10 with the base body 12 and the inserted liquid collector 14.

The base body 12 has a circular cover plate 22 and a circular bottom plate 24, which are aligned axially and parallel to one another and axially spaced apart from one another by a plurality of sidewalls 26a, b, c. The cover plate 22 has a larger diameter than the bottom plate 24 and acts as a heat shield for shielding the liquid propellant collected in the liquid collector 14 from hot propellant gases in the tank interior.

The sidewalls 26a, b, c extend in the circumferential direction and are uniformly spaced apart radially from the vertical axis or principal axis X such that a plurality of segment-shaped chambers 28a, 28b, 28c of identical size are formed. The sidewalls 26a, b, c are sheet-like and seal the individual chambers 28a, b, c against one another.

A few chambers 28a, b, c form the first region 16 and the other chambers form the second region 18. In the example shown, the chamber 28a spans 90° and forms the second region 18 whereas the remaining chambers 28b, c form the first region 16. In addition to segment-shaped geometries, it would naturally also be possible to choose other chamber geometries and a different number of chambers 28a, b, c. It is crucial that at least two chambers 28a, b, c are provided in order to form at least two regions 16, 18 that are separated from one another.

The chambers 28a, b, c are sealed axially upward and downward by the cover plate 22 and the bottom plate 24. On the circumference, the chambers 28a, b, c are completely open on the radially outer side.

Two not-shown outlet openings are formed in the bottom plate 24 and make it possible to feed the propellant from the first region 16 (chambers 28b, c) to the first outlet line 6 (main engine 2) and from the second region 18 (chamber 28a) to the second outlet line 8 (orbital engine 4).

The entire liquid collector 14 is arranged in the chamber 28a. Its radial extent corresponds to the radius of the bottom plate 24 such that the cover plate 22 forms a roof-like projection 30 on the radially outer side, wherein said roof-like projection promotes the retention of hot propellant gases (see also FIG. 1).

The liquid collector 14 is described in greater detail below with reference to FIGS. 3, 4 and 5.

The liquid collector 14 has a housing 31 that corresponds to the chamber 28a receiving the liquid collector. Accordingly, the housing 31 practically has a triangular shape and spans an angle of 90°. The housing 31 has a fluid-tight, plate-like housing roof 32, a fluid-tight, plate-like housing bottom 34 and a fluid-tight housing wall 36.

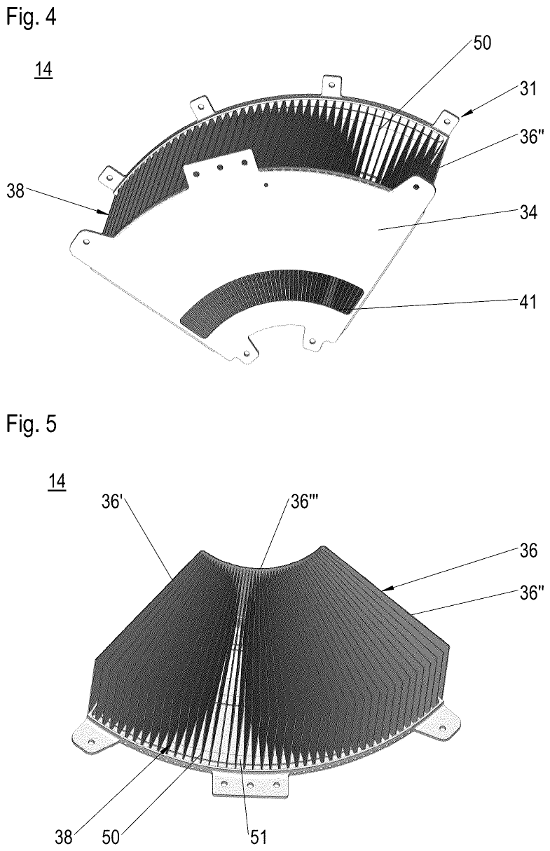

The housing roof 32 and the housing bottom 34 are spaced apart from one another in the vertical direction z and at the same time connected to one another by means of the housing wall 36. The housing wall 36 extends laterally of the housing roof 32 and the housing bottom 34, as well as radially inside thereof. Consequently, the housing wall 36 forms two housing sides 36′, 36″ and a housing back 36′″ (see FIGS. 4 and 5).

The housing wall 36 particularly is a bend sheet metal strip. The housing roof 32 and the housing bottom 34 are predominantly planar metal sheets.

The housing roof 32, the housing bottom 34 and the housing wall 36 delimit a receptacle space for the installation of a fan-like internal structure 38. The receptacle space is open on the radially outer side. An inlet opening 40 for receiving the liquid propellant particularly extends from a radially outer edge 42 of the housing bottom 34 up to a radially outer edge 44 of the housing roof 32 in the vertical direction z, as well as from one housing side 36′to the other housing side 36″ in the circumferential direction (transverse direction).

The edges 42, 44 may be bent inward (toward one another) as shown and represent an upper and a lower enclosure for the internal structure 38 on the side of the inlet opening. A plurality of holes 46, 48 may be produced in the edges 42, 44 in order to discharge gas from the receptacle space.

The fan-like internal structure 38 has a plurality of upright partition sheets 50 that are arranged radially adjacent to one another. The partition sheets 50 extend from the housing bottom 34 to the housing roof 32 and divide the receptacle space into a plurality of intermediate spaces 51 of identical size (see FIG. 5). They extend radially from the radially outer edges 42, 44 in the direction of the housing back 36′″, but are radially spaced apart from this rear housing wall.

Due to the radial arrangement of the partition sheets 50, the intermediate spaces 51 taper from the radially outer side (inlet opening 40) toward the radially inner side (outlet opening 41) such that the intermediate spaces 51 fill with liquid from the propellant tank 1 based on capillary forces.

The radial distance of the partition sheets 50 to the housing back 36′″ depends on their side clearance. The minimal distance of the partition sheets 50 to the rear housing back 36′″ is dimensioned in such a way that it does not exceed the minimal side clearance of the partition sheets 50.

According to FIG. 3, the partition sheets 50 may be respectively provided with at least one row of holes 52, 54 on their upper edges and on their lower edges such that upper and lower transverse connections between the intermediate spaces 51 are produced in order to discharge gas from the intermediate spaces 51. Three parallel rows of holes 52, 54 are respectively provided in the example shown. The spacing between the holes in each row of holes 52, 54 depends on the local side clearance from the adjacent partition sheets 50. For example, the hole spacing amounts to 1.3-times the distance from the adjacent partition sheet 50, i.e. it decreases radially from the outer side (inlet opening 40) toward the inner side (outlet opening 41) and increases from the outlet opening 41 toward the inlet opening 40 corresponding to the widening intermediate spaces 51.

Due to the size of the inlet opening 40, this inlet opening extends over all partition sheets 50 and intermediate spaces 51. The outlet opening 41 is arranged in the housing bottom 34 on the radially inner side. It extends over all partition sheets 50 and their intermediate spaces 51 just like the inlet opening 40 and has a crescent-like shape in the example shown (FIG. 5). The liquid from the propellant tank therefore is collected circumferentially and once again discharged axially. The outlet opening 41 is arranged in such a way that, when the housing 31 is inserted into the chamber 28a, it is aligned with the (not-shown) outlet opening for the second outlet line 8 (outlet line of the auxiliary engine 4).

The capillary forces cause the cryogenic propellant, e.g. liquid oxygen, to collect in the internal structure 38 during the ballistic flight phase such that it is subsequently available during the burn period of the orbital engine 4. The internal structure 38 of the liquid collector 14 empties during the operation of the engine when no liquid from the propellant tank 1 is accumulated around the liquid collector 14. Once liquid from the propellant tank 1 accumulates around the liquid collector 14, the internal structure 38 of the liquid collector once again fills with the cryogenic propellant from the propellant tank 1 under zero gravity conditions or under low acceleration based on the capillary forces acting upon the propellant. A system, which is designed in such a way that a residual quantity of propellant remains in the internal structure 38 when propellant is withdrawn via the first outlet line 6, is installed such that the liquid collector 14 is not emptied during the operation of the main engine 2.

The invention discloses a separation device for a cryogenic propellant tank of a rocket stage, wherein a secondary flow leading to the micropropulsion unit is structurally separated from a primary flow leading to a main engine, wherein a fan-shaped internal structure, through which the cryogenic liquid has to flow in order to reach the micropropulsion unit, is arranged in the inlet region of the secondary flow, wherein said internal structure is designed in such a way that it fills with liquid under zero gravity conditions and under only low acceleration, as well as during the operation of the micropropulsion unit under acceleration, and wherein the invention furthermore discloses a propellant tank for cryogenic propellants.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SYMBOLS

1 Propellant tank
2 Main engine
4 Auxiliary engine
6 First outlet line
8 Second outlet line
10 Separation device
12 Base body
14 Liquid collector
16 First region
18 Second region
22 Cover plate, heat shield function
24 Bottom plate
26a, b, c Sidewall
28a, b, c Chamber
30 Projection
31 Housing
32 Housing roof
34 Housing bottom
36 Housing wall
36′, 36″ Housing side
36′″ Housing back
38 Internal structure
40 Inlet opening
41 Outlet opening
42 Radially outer edge (housing bottom)
44 Radially outer edge (housing roof)
46 Hole in upper edge
48 Hole in lower edge
50 Partition sheet
51 Intermediate space
52 Upper row of holes (partition sheet)
54 Lower row of holes (partition sheet)
z Principal direction (separation device)
x Vertical direction (liquid collector)

Claimed is:

1. A separation device for installation in a propellant tank of a rocket stage for cryogenic liquid propellants, the separation device comprising:
a base body having at least one first region configured to be fluidically connected to a first outlet line of the propellant tank and at least one second region configured to be fluidically connected to a second outlet line of the propellant tank; and
at least one liquid collector arranged in the second region and having an inlet opening for receiving a propellant from a tank interior and an outlet opening for discharging the propellant,
wherein the at least one liquid collector has an internal structure configured such that the propellant enters the at least one liquid collector based on capillary forces.

2. The separation device of claim 1, wherein the internal structure comprises a plurality of partition sheets each having a side clearance which tapers from the inlet opening in a direction of the outlet opening.

3. The separation device of claim 2, wherein the plurality of partition sheets are arranged in a fluid-tight housing that is fluidically connected via the inlet opening and the outlet opening.

4. The separation device of claim 3, wherein the inlet opening is arranged radially outside on a circumference and the outlet opening is arranged radially inside axially in a housing bottom.

5. The separation device of claim 3, wherein the inlet opening and the outlet opening respectively extend over all partition sheets of the plurality of partition sheets.

6. The separation device of claim 5, wherein the plurality of partition sheets are spaced apart from a rear housing wall by a distance that is no greater than a minimal side clearance of the plurality of partition sheets.

7. The separation device of claim 5, wherein the plurality of partition sheets have at least one row of holes with a hole spacing of which depends on the side clearance of the plurality of partition sheets, in a bottom region, or a cover region, or both.

8. The separation device of claim 1, wherein, when propellant is withdrawn via the first outlet line, a residual quantity of propellant remains in the internal structure.

9. The separation device of claim 1, further comprising:
a heat shield to shield the at least one liquid collector from hot propellant gases in the tank interior.

10. A propellant tank for a rocket stage comprising:
the separation device according to claim 1.
